(19) United States
(12) Patent Application Publication
(10) Pub. No.: US 2006/0051637 A1
(43) Pub. Date: Mar. 9, 2006

(54) Fuel cell system and related method

(75) Inventors: Keiko Kushibiki, Fujisawa-shi (JP); Yasushi Nakajima, Kawasaki-shi (JP); Naoki Hara, Yokohama-shi (JP)

Correspondence Address: FOLEY AND LARDNER LLP;SUITE 500, 3000 K STREET NW, WASHINGTON, DC, 20007, US

(73) Assignee: Nissan Motor Co., LTD.

(21) Appl. No.: 10/542,407

(22) PCT Filed: Jan. 16, 2004
(86) PCT No.: PCT/JP04/00341

§ 371 Date: Jul. 15, 2005

(30) Foreign Application Priority Data
Jan. 30, 2003 (JP) 2003-022408

(51) Int. Cl. H01M 8/04

(52) U.S. Cl. 429/26; 429/34; 429/24; 429/17

(57) ABSTRACT

A fuel cell system is provided with a fuel cell (12) having a fuel electrode (19) supplied with fuel gas and an air electrode (16) supplied with oxidizer gas, a carbon dioxide separator (15, 52, 71) separating carbon dioxide from anode exhaust gas (25) expelled from the fuel electrode of the fuel cell, and a fuel vaporizer (13, 58) producing fuel gas by injecting fuel into anode exhaust gas, whose carbon dioxide is separated in the carbon dioxide separator and which is expelled from the carbon dioxide separator. Fuel gas produced in the fuel vaporizer is supplied to the fuel electrode of the fuel cell.

### TECHNICAL FIELD

The present invention relates to a fuel cell system and its related method and, more particularly, to a fuel cell system, which is equipped with a carbon dioxide separator, and its related method

### BACKGROUND ART

A fuel-cell electric power generation plant achieves electrochemical reaction of fuel of hydrocarbon system to convert it to water and carbon dioxide to cause a resulting difference in chemical enthalpy to be converted to electrical energy for thereby enabling electric power to be efficiently obtained. On the contrary, carbon dioxide necessarily results in.

Since such carbon dioxide has a probability to create a cause of global warming issues if it is released to the atmosphere as it is, a proposal has been made to provide a technology for removing carbon dioxide from anode exhaust gas, in Japanese Patent Application Laid-Open Publication No. H11-26004.

### DISCLOSURE OF INVENTION

However, upon considerable studying work done by the present inventors, depending on an electric power generation system with such a structure, no attempts to reuse fuel gas, which has been served for electric power generation, have been undertaken, it can not be said that an electric power generating efficiency of a whole system remains at a high level.

The present invention has been made upon such studies by the present inventors and especially has an object to provide a fuel cell system, wherein fuel gas served for electric power generation is reused and circulated in the system to allow fuel to be effectively utilized while concurrently enabling an electric power generating efficiency of a whole fuel cell system to be improved, and its related method.

According to one aspect of the present invention, a fuel cell system comprises: a fuel cell having a fuel electrode supplied with fuel gas and an air electrode supplied with oxidizer gas; a carbon dioxide separator separating carbon dioxide from anode exhaust gas expelled from the fuel electrode of the fuel cell; and a fuel vaporizer producing fuel gas by injecting fuel into the anode exhaust gas, whose carbon dioxide is separated in the carbon dioxide separator and which is expelled therefrom, with the fuel gas produced by the fuel vaporizer being supplied to the fuel electrode of the fuel cell.

Stated another way, according to another aspect of the present invention, a fuel cell system comprises: a fuel cell having a fuel electrode supplied with fuel gas and an air electrode supplied with oxidizer gas; carbon dioxide separating means for separating carbon dioxide from anode exhaust gas expelled from the fuel electrode of the fuel cell; and fuel injecting means for injecting fuel into the anode exhaust gas, whose carbon dioxide is separated in the carbon dioxide separating means and which is expelled therefrom, to produce gas, with the fuel gas produced by the fuel injecting means being supplied to the fuel electrode of the fuel cell.

In the meanwhile, according to the other aspect of the present invention, there is provided a method of circulating gas in a fuel cell system provided with a fuel cell having a fuel electrode supplied with fuel gas and an air electrode supplied with oxidizer gas, the method comprising: separating carbon dioxide from anode exhaust gas expelled from fuel electrode of a fuel cell; producing fuel gas by injecting fuel into the anode exhaust gas, whose carbon dioxide is separated and which is expelled; and supplying the fuel gas into the fuel electrode of the fuel cell.

Other and further features, advantages, and benefits of the present invention will become more apparent from the following description taken in conjunction with the following drawings.

### BRIEF DESCRIPTION OF DRAWINGS

FIG. 1 is schematic view illustrating an overall structure of a fuel cell system of a first embodiment according to the present invention;

FIG. 2 is a schematic view illustrating an internal structure of a carbon dioxide separator shown in FIG. 1, in the fuel cell system of the first embodiment;

FIG. 3 is schematic view illustrating an overall structure of a fuel cell system of a second embodiment according to the present invention;

FIG. 4 is a perspective view illustrating an external reformer shown in FIG. 3, in the fuel cell system of the second embodiment; and

FIG. 5 is schematic view illustrating an overall structure of a fuel cell system of a third embodiment according to the present invention.

### BEST MODE FOR CARRYING OUT THE INVENTION

A fuel cell system and its related method of each of embodiments according to the present invention are described hereunder in detail with suitable reference to the accompanying drawings.

### First Embodiment

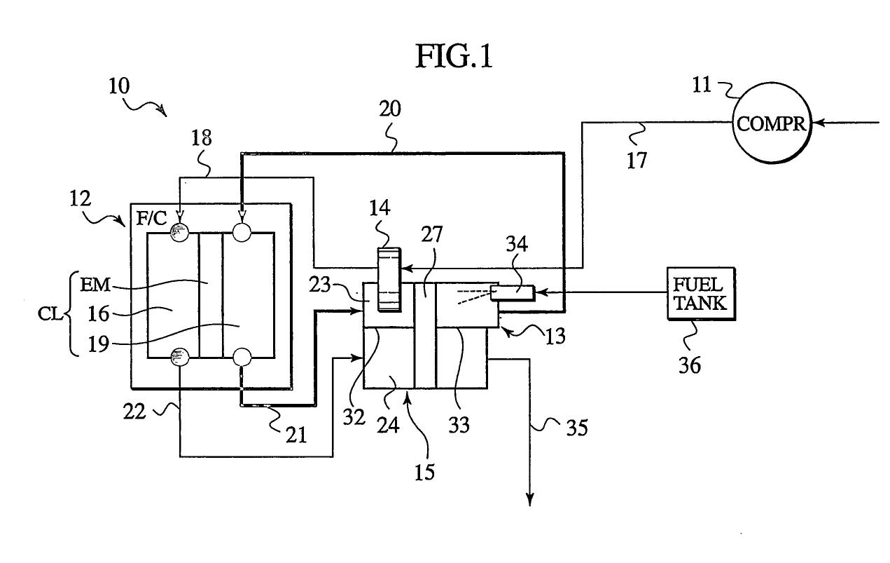

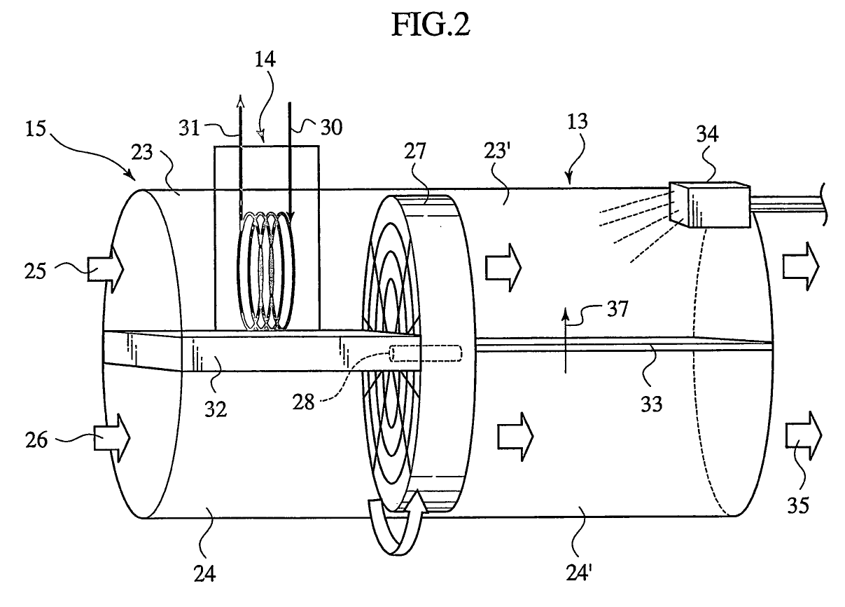

First, referring to FIGS. 1 and 2, a fuel cell system and its related method of a first embodiment of the present invention are described in detail.

FIG. 1 is a schematic view illustrating an overall structure of the fuel cell system of the presently filed embodiment, and FIG. 2 is a schematic view illustrating an internal structure of a carbon dioxide separator shown in FIG. 1.

As shown in FIGS. 1 and 2, the fuel cell system 10 is comprised of an air compressor 11, a fuel cell 12 and a fuel vaporizer 13 and, additionally, includes a hydrocarbon dioxide separator 15 having a heat-exchanger 14.

In order for compressed air to be delivered from the air compressor 11 to air electrodes 16 of the fuel cell 12 through the heat-exchanger 14 disposed in the carbon dioxide separator 15, a delivery conduit 17 is connected between the air compressor 11 and the heat-exchanger 14, and an air supply conduit 18 is connected between the heat-exchanger 14 and the fuel cell 12.

The fuel cell 12 includes a plurality of air electrodes 16 associated with a plurality of fuel electrodes 19, and a solid oxide fuel cell (SOFC), which is formed of electric power generating cells CL and separators (not shown) that are alternately laminated, is preferably used.

Although only a single piece of the electric power generating cells CL is representatively shown in FIG. 1, an electrolyte layer EM is made of oxide ion-conductive solid electrolyte, such as yttria stabilized zirconia (YSZ), and the electrolyte layer EM has one surface formed with the air electrode (cathode) 16 formed of lanthanum-manganese oxide and the other surface formed with the fuel electrode (anode) 19 formed of nickel-cerment. The separator has one surface formed with an air flow passage and the other surface formed with a fuel gas flow passage and has an electrically conducting function between the electric power generating cells. Also, an operating temperature of the SOFC lies at a high temperature in a range equal to or greater than approximately 600° C. and equal to or less than 1000° C.

That is, the electric power generating cells CL and the separators are alternately laminated under a condition where the fuel electrode 19 of the electric power generating cell CL and the fuel gas flow passage of the separator are disposed in opposition to one another and the air electrode 16 of the electric power generating cell CL and the air flow passage of the separator are disposed in opposition to one another, resulting in formation of the fuel cell 12.

Fuel gas is delivered to the plurality of fuel electrodes 19 formed inside the fuel cell 12 through a fuel gas supply conduit 20 disposed between the fuel vaporizer 13 and the fuel electrodes 19 of the fuel cell 12. Anode exhaust gas 25, resulting from such fuel gas being used for electric power generation, is delivered to the carbon dioxide separator 15 via an anode exhaust gas conduit 21 connected to the fuel cell 12 at one downstream port thereof.

Delivered through the air supply conduit 18 to the plurality of air electrodes 16 formed inside the fuel cell 12 is air, and cathode exhaust gas 26, resulting from such air being used for electric power generation, is delivered to the carbon dioxide separator 15 via a cathode exhaust gas conduit 22 connected to the fuel cell 12 at the other downstream port thereof.

The carbon dioxide separator 15 has an outer shape typically formed in a cylindrical shape, as shown in FIG. 2, and includes an upper anode exhaust gas flow passage 23 and a lower cathode exhaust gas flow passage 24 that are divided by and defined with a heat insulating wall portion 32.

Introduced into the anode exhaust gas flow passage 23 is anode exhaust gas 25 that is exhausted from the fuel electrodes 19 of the fuel cell 12, and introduced into the cathode exhaust gas flow passage 24 is cathode exhaust gas 26 that is exhausted from the air electrodes 16 of the fuel cell 12. That is, in respect of the anode exhaust gas flow passage 23 and the cathode exhaust gas flow passage 24 of the carbon dioxide separator 15, a left side indicates an upstream side and a right side indicates a downstream side in FIG. 2. The anode exhaust gas flow passage 23 and the cathode exhaust gas flow passage 24 are substantially defined with a carbon dioxide removing member 27, formed in a circular disc, in an axial direction (longitudinal direction) of the carbon dioxide separator 15, that is, in a direction in which exhaust gases flow from the upstream side to the downstream side.

The carbon dioxide removing member 27 has a radially center portion provided with a center shaft 28 (extending parallel to an axial direction of the carbon dioxide separator 15) that is rotatably supported. Since the anode exhaust gas flow passage 23 and the cathode exhaust gas flow passage 24 are separate from one another by the heat insulating wall portion 32 no heat, developed in the anode exhaust gas flow passage 23 prevailing at a high temperature, is substantially transferred to the cathode exhaust gas flow passage 24.

Within the carbon dioxide separator 15, the heat-exchanger 14 is located in the anode exhaust gas flow passage 23. The heat-exchanger 14 is comprised of a narrow supply pipe that is made of metal and wound while turning in a spiral shape and has one end 30 connected to the air compressor 11 while the other end 31 is connected to the air electrodes 16 of the fuel cell 12 to allow compressed air, emitting from the air compressor 11, to pass through an interior of the spiral supply pipe. Due to the presence of such compressed air prevailing at a low temperature, heat-exchange takes place for removing heat from the high temperature anode exhaust gas 25 flowing through the anode exhaust gas flow passage 23 during a time interval where compressed air passes through the spiral portion located in the anode exhaust gas flow passage 23, causing low temperature anode exhaust gas 25 to be delivered to the carbon dioxide removing member 27.

The carbon dioxide removing member 27 is made of a honeycomb member that can be used for operation at a high temperature, and carbon dioxide absorbing material is carried on a honeycomb ceramics, as a carrier. The carbon dioxide removing member 27 can be used in a so-called rotary regenerative type separator. As carbon dioxide absorbing material, use can suitably be made of material, containing lithium zirconate as main component, and is preferable to have a property to absorb carbon dioxide at a temperature ranging in a value equal to or greater than 300° C. and equal to or less than 700° C. in a particular temperature range while discharging carbon dioxide at a higher temperature than such a predetermined temperature ranging in the value equal to or greater than 300° C. and equal to or less than 700° C. That is to say, since the SOFC is the fuel cell that operates at a high temperature in a range equal to or greater than 600° C. and equal to or less than 1000° C., and a resulting exhaust gas temperature is higher than the carbon dioxide absorbing temperature that falls in the range equal to or greater than 300° C. and equal to or less than 700° C. Thus, by rotating and shifting the carbon dioxide removing member 27 from a position facing the anode exhaust gas flow passage 23, through which low temperature anode exhaust gas 25 flows, to the other position facing the cathode exhaust gas flow passage 24, through which high temperature cathode exhaust gas 26 flows, carbon dioxide absorbed by the carbon dioxide removing member 27 at the anode exhaust gas flow passage 23 can be released from the carbon dioxide removing member 27 at the cathode exhaust gas flow passage 24, resulting in a capability of efficiently removing carbon dioxide from anode exhaust gas 25.

That is, rotation of the carbon dioxide removing member 27 about the center shaft 28 enables repeated operations for alternately absorbing and releasing carbon dioxide such that when the carbon dioxide removing member 27 is positioned in the anode exhaust gas flow passage 23 remaining at a low temperature due to heat absorption by the heat-exchanger 14, the carbon dioxide removing member 27 absorbs carbon dioxide whereas when the carbon dioxide removing member 27 is shifted to the cathode exhaust gas flow passage 24, the carbon dioxide removing member 27 releases carbon dioxide. Also, such a structure is not limitative and another structure may be adopted provided that carbon dioxide can be alternately absorbed and released in a continuous fashion through rotation of the carbon dioxide removing member 27 or the like. Moreover, it is not objectionable to employ a structure wherein the carbon dioxide removing member is held stationary and a carbon dioxide absorbing section is disposed in a portion of the anode exhaust gas flow passage 23 of the carbon dioxide removing member while a carbon dioxide releasing section is disposed in a portion of the cathode exhaust gas flow passage 24 of the carbon dioxide removing member for thereby permitting carbon dioxide, absorbed by the carbon dioxide absorbing section, to be shifted to the carbon dioxide releasing section to cause carbon dioxide to be released.

Further, at a downstream side of the carbon dioxide removing member 27, the anode exhaust gas flow passage 23 communicates with an anode exhaust gas flow passage 23′ via the carbon dioxide removing member 27, and the cathode exhaust gas flow passage 24 communicates with a cathode exhaust gas flow passage 24′ via the carbon dioxide removing member 27. The anode exhaust gas flow passage 23′ and the cathode exhaust gas flow passage 24′ are elongated in and defined by the cylindrical hollow member unitarily formed with the carbon dioxide separator 15. The anode exhaust gas flow passage 23′ and the cathode exhaust gas flow passage 24′ are isolated from one another by means of a heat conductive wall section 33 through which heat change is able to take place.

Disposed in the anode exhaust gas flow passage 23′ is an injector 34 that protrudes into the flow passage for injecting fuel, with the injector 34 and the anode exhaust gas flow passage 23′ forming the fuel vaporizer 13. Also, the injector 34 is connected to a fuel tank 36 that stores fuel.

Next, operation of the fuel cell system with the structure set forth above is described below in conjunction with flows of air as oxidizer gas and fuel gas containing hydrogen.

As shown in FIG. 1, low temperature compressed air supplied from the air compressor 11 is delivered to the heat-exchanger 14, disposed in the carbon oxide separator 15, in which heat-exchange takes place with high temperature anode exhaust gas 25, and the temperature of compressed air increases. Then, compressed air passes through the air supply conduit 18 and delivered to the air electrodes 16 of the fuel cell 12. Within the fuel cell 12, oxygen gas in air is served for electric power generation, with resulting gas containing residual nitrogen being exhausted from the air electrodes 16 of the fuel cell 12. Such cathode exhaust gas 26 is supplied to the cathode exhaust gas flow passage 24 of the carbon dioxide separator 15.

In the meanwhile, fuel gas is obtained by vaporizing fuel delivered from the fuel tank 36 and sprayed by the injector 34 in a mist form. As fuel for the fuel cell 12, Hydrocarbon fuel, such as alcohol or natural gas, diesel oil and gasoline, can be used. Here, since heat 37 is transferred to the fuel vaporizer 13 from the cathode exhaust gas flow passage 34′ via the heat conductive wall section 33 that is heat-exchangeable, the fuel vaporizer 13 is retained at a high temperature. Accordingly, it is possible to efficiently vaporize fuel remaining in the mist form and to uniformly mix fuel to form fuel gas. Such fuel gas is delivered to the fuel electrodes 19 of the fuel cell 12 through the fuel gas supply conduit 20 and is served for electric power generation in the fuel cell 12, with resulting anode exhaust gas 25 being delivered to the anode exhaust gas flow passage 23 of the carbon dioxide separator 15. Contained in anode exhaust gas 25 are carbon dioxide, steam and hydrogen. Due to the occurrence of heat-exchange between anode exhaust gas 25 and low temperature compressed air by means of the heat-exchanger 14 of the carbon dioxide separator 15, the temperature of anode exhaust gas 25 is lowered to a value equal to or greater than 300° C. and equal to or less an 700° C. and, then, anode exhaust gas 25 reaches the carbon dioxide removing member 27 that rotates about the center shaft 28. Resulting anode exhaust gas 25 with carbon dioxide being selectively absorbed in the carbon dioxide removing member 27 and separated and removed therefrom, flows into the anode exhaust gas flow passage 23′ of the fuel vaporizer 13. And, operation is executed to sequentially repeat the cycle in that anode exhaust gas 25 is mixed with mist-like fuel sprayed by the injector 34 from the fuel ta 36 set forth above to form fuel gas which in turn is supplied to the fuel electrodes 19 of the fuel cell 12.

Here, while the carbon dioxide removing member 27, which absorbs carbon dioxide and rotates about the center shaft 28, is shifted to a position to face the cathode exhaust gas flow passage 24 of the carbon dioxide separator 15, since the temperature of cathode exhaust gas 26 of the cathode exhaust gas flow passage 24 remains at a high temperature greater than 700° C., the temperature of the carbon dioxide removing member 27 tends to exceed 700° C., with a resultant situation where carbon dioxide can be released. Consequently, since the carbon dioxide removing member 27 allows carbon dioxide to be released, exhaust gas 35 containing, in addition to nitrogen and oxygen, carbon dioxide passes through the cathode exhaust gas flow passage 24′ and is subjected to aft-treatment as occasion demands whereupon exhaust gas is exhausted to the outside of the system.

According to the fuel cell system 10 with the structure of the presently filed embodiment previously mentioned, since the flow passages at the upstream side of the carbon dioxide separator 15 is separated by the heat insulating wall portion 32, heat-exchange can be efficiently achieved through the use of the heat-exchanger 14.

Further, since the flow passages at the downstream side of the carbon dioxide separator 15 are separated from one another with the heat conductive wall section 33 having a heat conducting property, heat can be transferred from high temperature cathode exhaust gas 26 to the fuel vaporizer 13, enabling liquid-lie fuel to be efficiently vaporized.

Additionally, due to an ability of liquid fuel being discharged into high temperature exhaust gas subsequent to removal of carbon dioxide, it becomes possible to obtain fuel gas that is uniformly mixed and adequately vaporized, with resultant improvement over an electric power generating performance.

### Second Embodiment

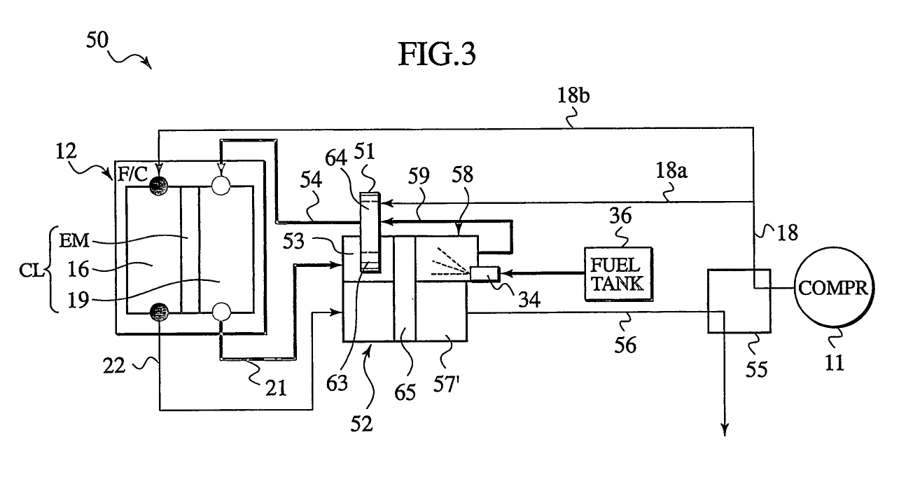

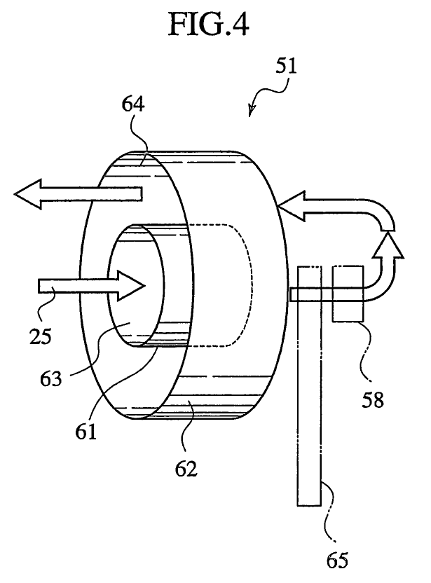

Now, referring to FIGS. 3 and 4, detailed description is made of a fuel cell system and its related method of a second embodiment of the present invention. The presently filed embodiment differs from the fuel cell system of the first embodiment principally in that anode exhaust gas is cooled using an external reformer as the heat-exchanger and, so, like component parts bear the same reference numerals while suitably making similar description in a simplified form or omitting the same.

FIG. 3 is a schematic view illustrating a fuel cell system 50 of the presently filed embodiment, and FIG. 4 is a perspective view illustrating an external reformer shown in FIG. 3

As shown in FIG. 3, the air supply conduit 18 extending from the air compressor 11 branches off via a heat exchanger 55 in two directions, with one supply conduit 18a being connected to an external reformer 51 while the other supply conduit 18b is connected to the air electrodes (cathodes) of the fuel cell 12. Disposed in a carbon dioxide separator 52 and protruding in an anode exhaust gas flow passage 53 is the external reformer 51 that provides a heat-exchange function. A supply conduit 54 extending from the external reformer 51 is connected to the fuel electrodes (anodes) 19 of the fuel cell 12.

Connected to a cathode exhaust gas flow passage 57 at a downstream side of a carbon dioxide removing member 65 is an exhaust pipe 56 that extends toward an air-compressor heat-exchanger 55, in which heat-exchange takes place between compressed air in the air supply conduit 18, extending from the air compressor 11, and cathode exhaust gas in the exhaust pipe 56.

A fuel vaporizer 58 is connected to the external reformer 51 via a conduit 59, permitting fuel gas vaporized in the fuel vaporizer 58 to be delivered to the fuel electrodes 19 of the fuel cell 12 via the external reformer 51.

As shown in FIG. 4 in detail, the external reformer 51 is formed in a double-tubular structure between an inner pipe 61 and an outer pipe 62. The external reformer 51 has a communicating section 63 for anode exhaust gas 25 defined inside the inner pipe 61 and includes a reformer-functioning section 64 defined between the inner pipe 61 and the outer pipe 62 through which fuel gas, vaporized in the fuel vaporizer, passes.

More particulary, the external reformer 51 has a structure wherein anode exhaust gas 25 is delivered to the carbon dioxide removing member 65 through the communicating section 63, which is disposed so as to form a part of the anode exhaust gas flow passage 53, and subsequently, fuel gas vaporized in the fuel vaporizer 58 is delivered to the reformer-functioning section 64 separated from the anode exhaust gas flow passage 53 to be supplied to the fuel electrodes 19. Thus, fuel gas is circulated by means of such an external reformer 51.

Introduced into the reformer-functioning section 64 are compressed air from the air compressor 11 and steam, with the amounts of air and steam to be introduced being controlled in relation to fuel gas flow to be circulated for enabling reforming reaction to take place in a steam reforming reaction mode that is endothermic reaction. Namely, the occurrence of heat-exchange between fuel gas to be reformed in endothermic reaction and anode exhaust gas 25 remaining at a temperature exceeding 700° C. allows anode exhaust gas 25 to be cooled to a temperature in a range equal to or greater than 300° C. and equal to or less than 700° C. while causing heat to be supplied to fuel gas for thereby promoting steam reforming reaction. Thus, by controlling even reaction of the external reformer 51 while performing temperature control of anode exhaust gas 25, carbon dioxide is absorbed from anode exhaust gas 25 and released into the outside, thereby enabling the function of the carbon dioxide separator 25 to be regenerated. In this case, steam can be contained in air from the air compressor 11 or also separately sprayed into the fuel vaporizer 58 while it can also be separately sprayed into an inlet portion of the reformer-functioning section 64 to be supplied thereto, or may contain moisture contained in anode exhaust gas 25.

With the fuel cell system 50 of the presently filed embodiment with the structure set forth above, new liquid fuel can be uniformly obtained utilizing heat of the carbon dioxide separator 52, while enabling the carbon dioxide separator 52 to continuously operate utilizing endothermic reaction of the external reformer 51.

Further, due to an ability of the fuel cell system of the reformer type which achieves cooling of anode exhaust gas 25 through the use of the existing external reformer 51, no separate heat-exchanger is newly required in such a fuel cell system, with a resultant capability of complying with a requirement at a low cost.

Incidentally, it is possible for the external reformer to use a structure that takes the form of the same construction as that of the heat-exchanger 14 shown in FIG. 2 while a reformer catalyst is carried on an interior of the delivery conduit

### Third Embodiment

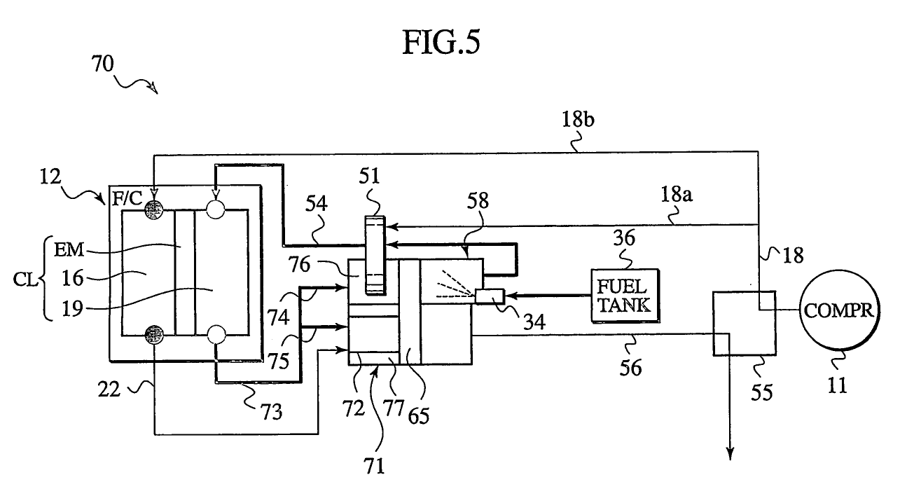

Now, referring to FIG. 5, detailed description is made of a fuel cell system and its related method of a third embodiment of the present invention. The presently filed embodiment differs from the fuel cell system of the second embodiment principally in that an exhaust gas combustor is disposed in a carbon dioxide separator and, so, like component parts bear the same reference numerals while suitably making similar description in a simplified form or omitting the same.

FIG. 5 is a schematic view illustrating a fuel cell system 70 of the presently filed embodiment.

As shown in FIG. 5, the fuel cell system 70 includes, in addition to the component elements of the fuel cell system 50 of the second embodiment, an exhaust gas combustor 72 which is located in a cathode exhaust gas flow passage 77, at the upstream side thereof, of a carbon dioxide separator 71. Also, the anode exhaust pipe 73 extending from the fuel electrodes (at an anode side) 19 of the fuel cell 12 branches off into a first branch conduit 74 and a second branch conduit 75 in two directions. The first branch conduit 74 communicates with an anode exhaust gas flow passage 76 of the carbon dioxide separator 71, and the second branch conduit 75 communicates with the exhaust gas combustor 72.

With the fuel cell system 70 of the presently filed embodiment, exhaust gas containing fuel, which is not completely consumed in the fuel cell stack 12, combusts in the exhaust gas combustor 72 to develop a high temperature, resulting in a capability of permitting carbon dioxide to be efficiently released from the carbon dioxide removing member 65. Moreover, anode exhaust gas expelled from the anode exhaust gas conduit 73 is delivered to the exhaust gas combustor 72 through the second branch conduit 75 while cathode exhaust gas is also delivered to the exhaust gas combustor 72, thereby enabling these exhaust gases to be efficiently combusted.

With the structures of various embodiments according to the present invention set forth above, since unburned combustible components contained in exhaust gases expelled from the fuel electrodes can be circulated and reused, thereby enabling the fuel components to be effectively utilized while achieving improvement over an electric power generating efficiency of a whole system.

Also, since concentration of carbon dioxide contained in the anode exhaust gas is effectively decreased by the carbon dioxide separator, such carbon dioxide can be prevented from being inadvertently releasing to atmosphere.

Incidentally, in the various embodiments, since gas circulating through the anodes is effective for adjusting a hydrogen concentration of the gas, it is desired to provide a path through which the gas is discharged to the outside of the circulation passage.

The entire content of a Patent Application No. TOKUGAN 2003-22408 with a filing date of Jan. 30, 2003 in Japan is hereby incorporated by reference.

Although the invention has been described above by reference to certain embodiments of the invention, the invention is not limited to the embodiments described above. Modifications and variations of the embodiments described above will occur to those skilled in the art in light of the teachings. The scope of the invention is defined with reference to the following claims.

### INDUSTRIAL APPLICABILITY

As previously noted, a fuel cell system according to the present invention allows unburned combustible components contained in exhaust gas exhausted from fuel electrodes of a fuel cell to be circulated for reuse, with carbon dioxide being removed. With such a structure, it is possible for the fuel components to be effectively utilized while achieving improvement over an electric power generating efficiency of the whole system, with application thereof being expected in a wide range involving a fuel cell powered automobile.

1. A fuel cell system comprising:
a fuel cell having a fuel electrode supplied with fuel gas and an air electrode supplied with oxidizer gas;
a carbon dioxide separator separating carbon dioxide from anode exhaust gas expelled from the fuel electrode of the fuel cell; and
a fuel vaporizer producing fuel gas by injecting fuel into the anode exhaust gas, whose carbon dioxide is separated in the carbon dioxide separator and which is expelled therefrom, with the fuel gas produced by the fuel vaporizer being supplied to the fuel electrode of the fuel cell.

2. The fuel cell system according to claim 1, wherein the carbon dioxide separator has a carbon dioxide removing member that absorbs and releases the carbon dioxide in dependence on a temperature of the anode exhaust gas.

3. The fuel cell system according to claim 2, wherein the carbon dioxide separator includes an anode exhaust gas flow passage, communicating with the fuel electrode of the fuel cell, and a cathode exhaust gas flow passage, communicating with the fuel electrode of the fuel cell, the anode exhaust gas flow passage and the cathode exhaust gas flow passage being separated from one another by a wall section,
and wherein the carbon dioxide removing member is rotatably disposed in a way to cover both of the anode exhaust gas flow passage and the cathode exhaust gas flow passage such that the carbon dioxide is absorbed at a temperature below a predetermined value whereas the carbon dioxide is released at a temperature exceeding the predetermined value.

4. The fuel cell system according to claim 3, further comprising a heat-exchanger disposed in the anode exhaust gas flow passage at an upstream side of the carbon dioxide removing member to cool the anode exhaust gas.

5. The fuel cell system according to claim 4, wherein the heat-exchanger performs heat-exchange with the anode exhaust gas using air supplied from an air compressor to decrease a temperature of the anode exhaust gas, and the air passing through the heat-exchanger is supplied to the air electrode of the fuel cell.

6. The fuel cell system according to claim 3, wherein the wall section of the carbon dioxide separator has a heat insulating property at an upstream side of the carbon dioxide removing member.

7. The fuel cell system according to claim 3, wherein the anode exhaust gas flow passage and the cathode exhaust gas flow passage of the carbon dioxide separator communicate with an anode exhaust gas flow passage and a cathode exhaust gas flow passage at downstream sides of the carbon dioxide removing member, respectively, and the anode exhaust gas flow passage and the cathode exhaust gas flow passage prevailing at the downstream sides of the carbon dioxide removing member are separated from one another by a wall section having a thermal conductivity.

8. The fuel cell system according to claim 7, wherein the fuel vaporizer injects the fuel into the anode exhaust gas flow passage at the downstream side of the carbon dioxide removing member to form the fuel gas.

9. The fuel cell system according to claim 4, wherein the heat-changer performs heat-exchange with the anode exhaust gas using the fuel gas vaporized in the fuel vaporizer to decrease a temperature of the anode exhaust gas, and the fuel gas passing through the heat-exchanger is supplied to the fuel electrode of the fuel cell.

10. The fuel cell system according to claim 9, wherein the heat-exchanger includes a reformer device that causes reforming reaction in endothermic reaction.

11. The fuel cell system according to claim 10, wherein the reforming reaction of the heat-exchanger involves steam reforming reaction.

12. The fuel cell system according to claim 1, further comprising an exhaust gas combustor disposed in the cathode exhaust gas flow passage of the carbon dioxide separator at an upstream side of the carbon dioxide removing member, a portion of the anode exhaust gas exhausted from the fuel electrode of the fuel cell being supplied into the combustor.

13. A fuel cell system comprising:
a fuel cell having a fuel electrode supplied with fuel gas and an air electrode supplied with oxidizer gas;
carbon dioxide separating means for separating carbon dioxide from anode exhaust gas expelled from the fuel electrode of the fuel cell; and
fuel injecting means for injecting fuel into the anode exhaust gas, whose carbon dioxide is separated in the carbon dioxide separating means and which is expelled therefrom, to produce gas, with the fuel gas produced by the fuel injecting means being supplied to the fuel electrode of the fuel cell.

14. A method of citing gas in a fuel cell system provided with a fuel cell having a fuel electrode supplied with fuel gas and an air electrode supplied with oxidizer gas, the method comprising;
separating carbon dioxide from anode exhaust gas expelled from fuel electrode of a fuel cell;
producing fuel gas by injecting fuel into the anode exhaust gas, whose carbon dioxide is separated and which is expelled; and
supplying the fuel gas into the fuel electrode of the fuel cell.
